(19) United States
(12) Patent Application Publication
(10) Pub. No.: US 2023/0216194 A1
(43) Pub. Date: Jul. 6, 2023

(54) MINIATURIZED MULTIFUNCTIONAL ULTRAWIDEBAND ANTENNA SYSTEM

(71) Applicants: MALATHI KANAGASABAI, CHENNAI (IN); GULAM NABI ALSATH MOHAMMED, CHENGALPATTU (IN); SANDEEP KUMAR PALANISWAMY, CHENGALPATTU (IN); RAMA RAO THIPPARAJU, CHENGALPATTU (IN); SACHIN KUMAR, CHENGALPATTU (IN); SISIR KUMAR DAS, KOLAKATTA (IN); PADMATHILAGAM SAMBANDAM, CHENNAI (IN); VIKNESWARAN MURUGESAN, CHENNAI (IN)

(72) Inventors: MALATHI KANAGASABAI, CHENNAI (IN); GULAM NABI ALSATH MOHAMMED, CHENGALPATTU (IN); SANDEEP KUMAR PALANISWAMY, CHENGALPATTU (IN); RAMA RAO THIPPARAJU, CHENGALPATTU (IN); SACHIN KUMAR, CHENGALPATTU (IN); SISIR KUMAR DAS, KOLAKATTA (IN); PADMATHILAGAM SAMBANDAM, CHENNAI (IN); VIKNESWARAN MURUGESAN, CHENNAI (IN)

(21) Appl. No.: 17/646,687

(22) Filed: Dec. 31, 2021

(51) Int. Cl. H01Q 25/00; H01Q 9/04; H01Q 19/00; H01Q 5/25; H01Q 5/335

(52) U.S. Cl. CPC H01Q 25/002; H01Q 9/0414; H01Q 19/005; H01Q 5/25; H01Q 9/0471; H01Q 9/045; H01Q 5/335

(57) ABSTRACT

The embodiments herein provide a miniaturized multifunction ultra-wideband antenna comprising an omnidirectional radiator and unidirectional radiator. The planar Square Monopole Antenna (SMA) with a maximum dimension of λg/5 provides a 10:1 ultra-wide bandwidth with an omnidirectional radiation pattern. The coplanar waveguide technology is the technology incorporated along with Heptagonal Microstrip Patch Antenna (HMPA) placed above a Full Ground Plane (FGP) to achieve unidirectional radiation pattern. The Heptagonal Microstrip Patch Antenna (HMPA) backed with the Pi shaped Parasitic Patch (PSPP) is electromagnetically coupled to the Full Ground Plane (FGP) through the Shorting Pins (SP). Good isolation is achieved through the orthogonal arrangement segregated with the Square Slot (SS) and Inverted L shaped slot (ILSS). The stacked quasi TEM structure backed with a Partial Ground Plane (PGP) are configured on a single platform providing unidirectional and omnidirectional radiation pattern for short-range sensing and indoor communications.

### TECHNICAL FIELD

The present invention is related to microwave antennas and more particularly a miniaturized multifunctional ultra-wideband antenna system is conformal for mounting on a platforms such as short-range radar sensing and indoor wireless communication.

### BACKGROUND OF THE INVENTION

Rapid development of technologies and the objective of improving the quality of life lead to tremendous growth in wireless communication. Antennas play a crucial role in wireless communication systems. Since FCC granted permission for the utilization of an unlicensed band with a bandwidth of 7.5 GHz (3.1-10.6 GHz), ultra-wideband (UWB) radio technology has created much attention for wireless communication. UWB Antennas have high resilience to fading and offer a high data rate of 110-480 Mbps due to large bandwidth. Low power spectral density is yet another attractive feature of UWB over conventional narrowband wireless communication techniques. UWB antennas are generally required to be compact, possess good efficiency and short impulse responses, and can be easily integrated with circuitry. Unlike narrowband channels, UWB channels inexperience deep-fades. On the other hand, when incorporated in devices, emitted power should be maintained below a certain mask. This would limit the SNR and range which can be overcome by utilizing antenna diversity. To introduce diversity, multiple antennas are required to provide independent sub-channels.

Pattern diversity is one of the diverse techniques that use different radiation patterns for different scenarios. Generally, omnidirectional radiation characteristics are preferred for nearfield communication to collect data from neighboring devices, and directional radiation characteristics are preferred for far-field communication to interact with distant systems. Large size, high profile, complex structures, poor isolation between antennas and the need for an active element (introduces non-linearity in systems) to switch between antennas are major concerns in MIMO antennas. Conventional pattern diversity antenna is designed by holding either omnidirectional or directional radiation characteristics with diversity performance. In those diversity antennas, the prime aim is to increase the data rate, but in this work, the aim is to provide different roles to each antenna in addition to data rate improvement. This is the first initiative that integrates omnidirectional UWB antenna and directional UWB antenna together into a single PCB board. The proposed antenna is designed by overcoming the issues mentioned above with quintessential features such as compact, low profile, simple design, and good radiation efficiency.

### OBJECTIVE OF THE INVENTION

The primary objective of the present invention is to design a miniaturized multifunctional antenna system.

Yet another objective of the present invention is to design a compact microstrip radiator backed with a parasitic patch using coplanar waveguide technology that can provide a continuous resonance for the entire ultra-wideband accompanied with unidirectional radiation pattern.

Yet another objective of the present invention is to design a monopole radiator with the smallest form factor providing ultra-wide bandwidth along with an omnidirectional radiation pattern.

Yet another objective of the present invention is to reduce the coupling effect between the two radiators integrated into a single platform through the orthogonal arrangement.

These and other objects and advantages of the present invention will become readily apparent from the following detailed description taken in conjunction with the accompanying drawings.

### SUMMARY OF THE INVENTION

The various embodiments of the present invention provide a multifunctional antenna system to provide a plurality of radiation characteristics with minimum interference between the radiators. The embodiments of the present invention provide a miniaturized multifunctional antenna system comprising of a Heptagonal Microstrip Patch Antenna (HMPA) coupled with the Trapezoidal coplanar waveguide (TCW) and a Square Monopole Antenna (SMA) are positioned above an Inverted L shaped Conducting Ground Plane (ILCGP) to provide resonance for the entire ultra-wideband frequency range. According to an embodiment, the miniaturized multifunctional antenna system, includes a Heptagonal Microstrip Patch Antenna (HMPA) coupled to a Pi shaped Parasitic Patch (PSPP) and integrated with Trapezoidal coplanar waveguide (TCP) and a Square Monopole Antenna (SMA) are placed above an Inverted L shaped Conducting Ground Plane (ILCGP) configured to provide the distinct radiation characteristics for the desired resonance.

According to an embodiment, the unidirectional radiator includes a Trapezoidal coplanar waveguide (TCP) waveguide coupled to a Pi shaped Parasitic Patch (PSPP) and configured to provide the desired resonance utilizing the quasi TEM structure.

According to an embodiment, the unidirectional radiator includes a Trapezoidal coplanar waveguide (TCP), capacitively coupled to the Full Ground Plane (FGP) through the Shorting Pins (SP) which enhance the bandwidth in the highest frequency range of the ultra-wideband (UWB).

According to an embodiment, the unidirectional radiator includes a Heptagonal Microstrip patch antenna (HMPA) is obtained using the truncation method to provide the lowest resonance of the desired application band which reduces the overall area of the antenna system.

According to an embodiment, the unidirectional radiator includes a Trapezoidal coplanar waveguide (TCP) is obtained using the truncation technique to achieve better impedance matching in the lowest frequency range of the desired application band.

According to an embodiment, the unidirectional radiator includes, Square Slots (SS) are incorporated near the lower region of the microstrip patch to achieve better impedance matching in the highest frequency range of the desired application band.

According to an embodiment, the omnidirectional radiator includes, a Square Monopole Antenna (SMA) that provides the lowest resonance by altering the physical length of the radiators.

According to an embodiment, the omnidirectional radiator includes a Square Monopole Antenna (SMA) backed with a Partial Ground Plane (PGP) to enhance the bandwidth in the desired application bands.

According to an embodiment, the miniaturized multifunctional antenna system includes a unidirectional radiator and omnidirectional radiator configured in the orthogonal arrangement placed above an Inverted L shaped conducting ground plane (ILCGP) to enhance the isolation between the antenna elements.

According to an embodiment, the miniaturized multifunctional antenna system includes a unidirectional radiator and omnidirectional radiator separated by Square Slot (SS) and Inverted L Shaped Slot (ILSS) are incorporated in the Inverted L shaped conducting ground plane (ILCGP) to further reduce the coupling effect between the antenna elements.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG. 1 illustrates a front view of the miniaturized multifunctional antenna system according to one embodiment of the present invention.

FIG. 2 illustrates a back view of the miniaturized multifunctional antenna system of FIG. 1, according to an embodiment of the present invention.

FIG. 3 illustrates a side view of the miniaturized multifunctional antenna system of FIG. 1, according to an embodiment of the present invention.

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the present invention provide a multifunctional antenna system to provide a plurality of radiation characteristics with minimum interference between the radiators. The embodiments of the present invention provide a miniaturized multifunctional antenna system comprising of a Heptagonal Microstrip Patch Antenna (HMPA) coupled with the Trapezoidal coplanar waveguide (TCW) and a Square Monopole Antenna (SMA) are positioned above an Inverted L shaped Conducting Ground Plane (ILCGP) to provide resonance for the entire ultra-wideband frequency range. According to an embodiment, the miniaturized multifunctional antenna system, includes a Heptagonal Microstrip Patch Antenna (HMPA) coupled to a Pi shaped Parasitic Patch (PSPP) and integrated with Trapezoidal coplanar waveguide (TCP) and a Square Monopole Antenna (SMA) are placed above an Inverted L shaped Conducting Ground Plane (ILCGP) configured to provide the distinct radiation characteristics for the desired resonance.

According to an embodiment, the unidirectional radiator includes a Trapezoidal coplanar waveguide (TCP) waveguide coupled to a Pi shaped Parasitic Patch (PSPP) and configured to provide the desired resonance utilizing the quasi TEM structure.

According to an embodiment, the unidirectional radiator includes a Trapezoidal coplanar waveguide (TCP), capacitively coupled to the Full Ground Plane (FGP) through the Shorting Pins (SP) which enhance the bandwidth in the highest frequency range of the ultra-wideband (UWB).

According to an embodiment, the unidirectional radiator includes a Heptagonal Microstrip patch antenna (HMPA) is obtained using the truncation method to provide the lowest resonance of the desired application band which reduces the overall area of the antenna system.

According to an embodiment, the unidirectional radiator includes a Trapezoidal coplanar waveguide (TCP) is obtained using the truncation technique to achieve better impedance matching in the lowest frequency range of the desired application band.

According to an embodiment, the unidirectional radiator includes, Square Slots (SS) are incorporated near the lower region of the microstrip patch to achieve better impedance matching in the highest frequency range of the desired application band.

According to an embodiment, the omnidirectional radiator includes, a Square Monopole Antenna (SMA) that provides the lowest resonance by altering the physical length of the radiators.

According to an embodiment, the omnidirectional radiator includes a Square Monopole Antenna (SMA) backed with a Partial Ground Plane (PGP) to enhance the bandwidth in the desired application bands.

According to an embodiment, the miniaturized multifunctional antenna system includes a unidirectional radiator and omnidirectional radiator configured in the orthogonal arrangement placed above an Inverted L shaped conducting ground plane (ILCGP) to enhance the isolation between the antenna elements.

According to an embodiment, the miniaturized multifunctional antenna system includes a unidirectional radiator and omnidirectional radiator separated by Square Slot (SS) and Inverted L Shaped Slot (ILSS) are incorporated in the conducting ground plane to further reduce the coupling effect between the antenna elements.

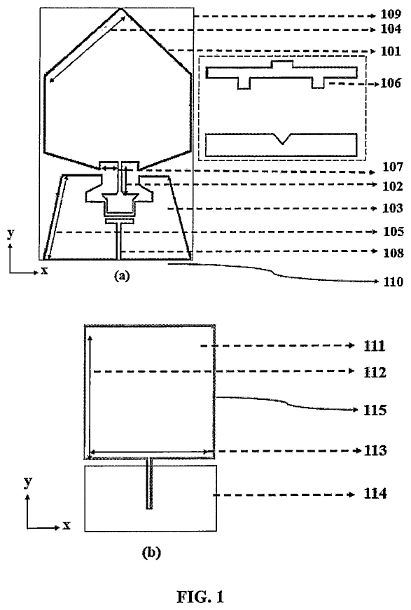

FIG. 1 illustrates a multifunctional ultra-wideband antenna system 100, according to one embodiment of the present invention. The antenna system includes a unidirectional radiator containing a Heptagonal Microstrip Patch antenna (HMPA) 101 referred to as Quasi TEM structure, Trapezoidal Coplanar Waveguide (TCP) 103, Pi shaped Parasitic Patch (PSPP) 106 and Shorting Pins (SP) 301 & 302 backed with a Full ground Plane (FGP) and an omnidirectional radiator containing a planar Square Monopole Antenna (SMA) 102 backed with a Partial Ground Plane (PGP). Typically a length of the monopole antenna 107 and a width of the monopole antenna 108 is designed to provide the required application band. In an embodiment, the monopole antenna 102 printed on a Rogers's substrate 304 & 305 having a width of 0.2 mm and a relative permittivity (εr) of 3.55 with a tangent loss 0.002.

Further, the omnidirectional radiator is designed based on simple monopole technology. It is a resonant antenna which functions as an open resonator for radio waves, standing waves of voltage and current along its length gets oscillated. In embodiments, the length of the antenna 107 is determined by the wavelength of the radio waves it is used with. The most common form is the quarter-wave monopole, in which the antenna is approximately one-quarter of the wavelength of the radio waves.

Further, the unidirectional radiator is implemented with different broad-banding concepts to obtain ultra-wideband and to compensate for the impedance mismatch created by the inductances of the coaxial probe (P1 & P2). Bandwidth can be further increased by introducing a connection between two conductor plates of Trapezoidal coplanar waveguide (TCP) (with the ground) by Shorting Pins (SP) 301,302 that enhances capacitive coupling. The middle layer contains the Pi shaped Parasitic Patch (PSPP) 106 paves the way for ultra-wideband. To design unidirectional radiator, initially, the center frequency of the UWB band is selected and a conventional narrowband patch antenna is designed to radiate in center frequency. When this patch antenna is incorporated with coplanar waveguide (with the ground), it introduces quasi-TEM mode due to the air interface 303 between conductor parts resulting in increasing bandwidth to a certain extent in the lower UWB frequency range. To cover the entire UWB resonance, the coupling should take place in the entire band. Pi shaped Parasitic patch (PSPP) 107 contributes the bandwidth enhancement in the mid operating frequency range through capacitive coupling. Truncation 105 has been implemented in a coplanar waveguide which helps in reducing overall antenna size, maintains the wideband behavior and also improves impedance matching without affecting the bandwidth. Optimization is done by Square Slots (SS) 109 to remove unnecessary notches. The T Shaped Slots (TSS) 110 are incorporated in the Trapezoidal coplanar waveguide (TCP) 103 to achieve better impedance matching in the lower UWB frequency range. The Full Ground Plane (FGP) positioned below the Heptagonal Microstrip Patch Antenna (HMPA) is incorporated with F Shaped slots (FSS) 203 to provide the lowest resonance of the UWB frequency range.

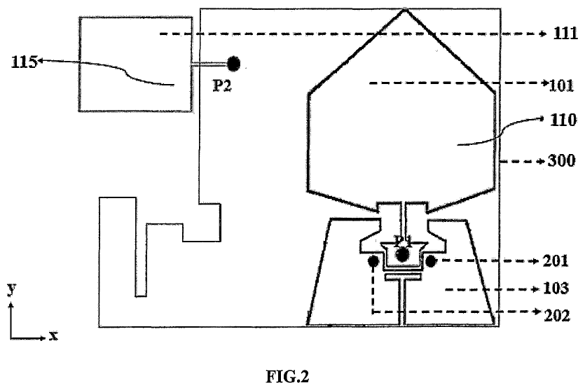

FIG. 2 illustrates a conducting ground plane 200 of the miniaturized multifunctional antenna system 100. The Inverted L shaped conducting ground plane (ILCGP) is incorporated with a Square Slot (SS) 201 and an Inverted L Shaped Slot (ILSS) 202 to enhance the isolation between the antenna elements. In an embodiment, the orthogonal arrangement of Square Monopole Antenna (SMA) 102 with Heptagonal Microstrip Patch Antenna (HMPA) 101 further reduces the coupling between the antenna elements. The dual feed element delivers the available power to the omnidirectional radiator and unidirectional radiator using a separate feeding network. Thus this Inverted L shaped conducting ground plane (ILCGP) 200 is said to be a base element of the antenna system capable of providing both omnidirectional and directional radiation characteristics. Using a multi-functional antenna system it is possible to discriminate the desired signals according to the user demand by proficiently mitigating the undesirable signals.

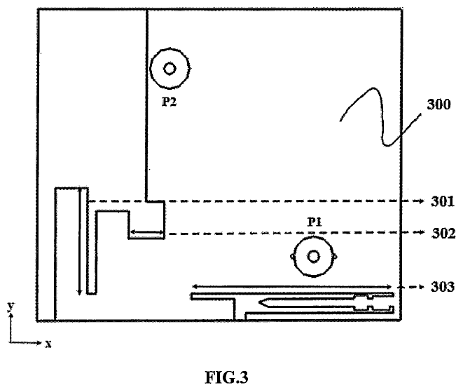

FIG. 3 illustrates a side view of the miniaturized multifunctional antenna system 100 containing a four layers with Heptagonal microstrip patch antenna (HMPA) with Trapezoidal coplanar waveguide (TCW) 103 present in the top layer; Pi shaped Parasitic Patch (PSPP) 106 in the second layer; the third layer contains square monopole antenna (SMA) 102 and bottom layer with the Inverted L shaped conducting ground plane (ILCGP) 200. The top two layers (first and second layer) and bottom two layers (third and fourth layer) are segregated by Rogers 4003C substrate. The top layer containing a Heptagonal microstrip patch antenna (HMPA) with Trapezoidal coplanar waveguide (TCW) 103 and the bottom layer containing a Conducting Ground Plane (CGP) are electromagnetically coupled by introducing a connection between two conductor plates of coplanar waveguide (with the ground) through the shorting pins 301 & 302. The middle layer contains a Pi shaped Parasitic Patch 106 paves the way for ultra-wideband. Directional and omnidirectional antennas are separated by an air gap 303 of 2 mm to achieve better isolation and bandwidth enhancement.

As a result, the multifunctional antenna system provides a continuous resonance for the entire ultra-wideband suitable for short-range communication. The antenna system radiates only at desired bands with the reflection coefficient above −10 dB and isolation less than −10 dB. The multifunctional antenna system 100 offers omnidirectional and directional radiation pattern with spectrum efficiency, reduced fading, better isolation characteristics, and receiver connectivity suitable for radar sensing both in the near field and far field short-range communication.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. Although the embodiments herein are described with various specific embodiments, it will be obvious for a person skilled in the art to practice the embodiments herein with modifications.

### ADVANTAGES OF THE INVENTION

The embodiments of the present invention provide a miniaturized multifunctional antenna system using a plurality of radiators comprises of monopole radiator and microstrip patch providing a distinct radiation characteristic such as omnidirectional and directional pattern and hence most feasible for radar sensing.

The embodiments of the present invention provide an antenna system developed on a thin and low-cost dielectric substrate providing an easy fabrication and reducing the cost of the overall system.

The embodiments of the present invention provide a miniaturized multifunctional antenna system using a plurality of radiators configured to provide the lowest resonance of ultra-wide bandwidth by varying the physical length of the radiators.

The embodiments of the present invention provide a unidirectional radiator comprises of a combination of simple techniques such as coplanar waveguide technology and coupled resonance method integrated with quasi TEM waves providing ultra-wide bandwidth and hence it is highly suited for long-range communication.

The embodiments of the present invention provide an independent utilization of each radiator using a separate feeding network as per the receiver connectivity in the service environment.

The embodiments of the present invention provide a multifunctional antenna using a plurality of radiators which provides a good spectrum efficiency and improves the receiver sensitivity without affecting the radiation properties of the antenna system.

The embodiments of the present invention facilitate a stable omnidirectional and directional radiation pattern with considerable gain and efficiency utilizing symmetrical radiators with a small aperture width.

We claim:

1. A miniaturized multifunctional ultra-wideband antenna system 100 comprising:
An omnidirectional radiator comprises of a Square Monopole Antenna (SMA) 102 backed with a Partial Ground Plane (PGP).
A unidirectional radiator is a combination of stacked three layers comprising:
A First layer, Heptagonal Microstrip Patch Antenna (HMPA) 101 coupled to the feed line to provide the required upper UWB resonance.
Trapezoidal coplanar Waveguide (TCP) 103 asides the feed line incorporated in the first layer contributes for the bandwidth enhancement in the required lower UWB frequency range.
A Middle layer, Pi shaped Parasitic patch (PSPP) 106 provides the continuous resonance in the mid UWB frequency range.
A Third layer, Full Ground Plane (FGP) incorporated with F shaped slots (FSS) 203 is positioned below the unidirectional radiator.
Shorting Pins (SP) 301 & 302, utilized for connecting the first layer, middle layer, and the third layer.
an Inverted L shaped conducting ground plane (ILCGP) 200 is a combination of Partial Ground Plane (PGP) and Full Ground Plane (FGP) segregated with square slots (SS) 201 and Inverted L shaped slots (ILS) 202.
a dual-feed network consists of two different feed networks, one for unidirectional radiator (P1) and another for the omnidirectional radiator (P2).

2. The multifunctional ultra-wideband antenna system 100 as claimed in claim 1, wherein the omnidirectional radiator achieves the lowest resonance of the ultra-wide bandwidth by altering the physical length 107 of the Square Monopole Antenna (SMA).

3. The multifunctional ultra-wideband antenna system 100 as claimed in claim 1, wherein the Square Monopole Antenna (SMA) 102 is backed with a Partial Ground Plane (PGP) to provide the continuous resonance for the entire UWB frequency range.

4. The multifunctional ultra-wideband antenna system 100 as claimed in claim 1, wherein a Heptagonal Microstrip Patch Antenna (HMPA) 101 is incorporated with Square Slots (SS) 109 near the feed line to achieve the impedance matching in the obtained upper UWB frequency range.

5. The multifunctional ultra-wideband antenna system 100 as claimed in claim 1, wherein a Trapezoidal coplanar Waveguide (TCP) 103 is incorporated with T Shaped Slots (TSS) 110 to provide the impedance matching in the obtained lower UWB frequency range.

6. The multifunctional ultra-wideband antenna system 100 as claimed in claim 1, wherein a Pi shaped Parasitic patch (PSPP) 106 contributes to the bandwidth enhancement for the mid UWB frequency range through the resonance coupling technique.

7. The multifunctional ultra-wideband antenna system 100 as claimed in claim 1, wherein stacked layers of the unidirectional radiator are capacitively coupled to the conducting ground plane through the shorting pins (SP) 301 & 302 which aid in the continuous resonance for the entire UWB frequency range.

8. The multifunctional ultra-wideband antenna system 100 as claimed in claim 1, wherein a Modified F Shaped Slot (MFSS) 203 is incorporated near the lower region of the Full Ground Plane (FGP) to provide the required lowest UWB resonance of the unidirectional radiator.

9. The multifunctional ultra-wideband antenna system 100 as claimed in claim 1, wherein conducting ground plane (CGP) 200 is of inverted L shape, which is being positioned as a base of the antenna system covers at least three-fourth of the total dimensional area.

10. The multifunctional ultra-wideband antenna system 100 as claimed in claim 1, wherein the unidirectional radiator (101) and an omnidirectional radiator (102) arranged in an orthogonal manner to reduce the coupling effect.

11. The multifunctional ultra-wideband antenna system 100 as claimed in claim 1, wherein the additional square slot (SS) 201 and Inverted L shaped slot (ILSS) 202 are incorporated in the conducting ground plane between the omnidirectional radiator and unidirectional radiator to further reduce the coupling effects.

12. The multifunctional ultra-wideband antenna system 100 as claimed in claim 1, wherein a plurality of radiators facilitates a distinct radiation pattern with stable characteristics through the symmetrical geometry.

13. The multifunctional ultra-wideband antenna system 100 as claimed in claim 1, wherein a plurality of radiators are separately fed by using a coaxial probe (P1 & P2) thereby the antenna system can be operated either in a unidirectional radiator or omnidirectional radiator or both simultaneously according to the users demand in the rich scattered environment and hence suits well for wireless communication.
